(19) United States
(12) Patent Application Publication
(10) Pub. No.: US 2026/0309121 A1
(43) Pub. Date: Oct. 8, 2026

(54) HYDRAULIC MOTOR

(71) Applicant: WORLDPOWER AS, Larvik (NO)

(72) Inventors: Bendik Bø, Larvik (NO); Gagi Peskovic, Larvik (NO)

(21) Appl. No.: 19/472,242

(22) PCT Filed: Apr. 5, 2024
(86) PCT No.: PCT/IB2024/053345

§ 371 Date: Oct. 3, 2025

(30) Foreign Application Priority Data
Apr. 5, 2023 (NO) 20230388

(51) Int. Cl. F03C 1/40

(52) U.S. Cl. CPC F03C 1/045

(57) ABSTRACT

A hydraulic motor for energy conversion and method for operating a hydraulic motor5 for energy conversion are provided. The present invention attains the above-described objective by a pressure annulling unit that can selectively annul the ambient pressure outside the pressure annulling unit.

### BACKGROUND OF THE INVENTION

### Field of the Invention

The invention relates to mechanical conversion in general and more specifically a system and a method for a hydraulic motor.

### Background Art

State of the art is reflected in traditional hydraulic systems such as hydraulic cylinders.

From prior art one should refer to hydraulics, wherein a cylinder is pressurised to displace a piston located within the cylinder. The pressure works against the load connected to the piston and also the ambient pressure. At great depth, the ambient pressure becomes significant, and a greater pressure is needed to provide a sufficient overpressure to overcome the effect of the ambient pressure.

CN 115467867 A discloses, according to a translation of the abstract, a pressure equalizing device, a hydraulic system and an operation machine, wherein the pressure equalizing device comprises a valve body, an oil drainage main pipeline, an opening valve element and a pressure adjusting assembly, the valve body is provided with an oil drainage cavity, a first oil port and a second oil port, the first oil port and the second oil port communicate with the oil drainage cavity, the first oil port communicates with an oil drainage port of a hydraulic motor, and the second oil port communicates with an oil drainage port of the hydraulic motor; the second oil port is communicated with the oil drainage main pipeline, the opening valve element seals the first oil port, and the opening valve element is movably arranged in the oil drainage cavity; when the pressure of the oil drainage main pipeline is larger than the external atmospheric pressure, the pressure adjusting assembly applies first pressure to the opening valve element.

EP 3222856 A1 discloses, according to a translation of the abstract, a self-contained pressure compensation system and a control method thereof, wherein the self-contained pressure compensation system comprises a oil supply device, a pressure compensation device, a power unit associated with the pressure compensation device, and a switch control device, the pressure compensation device supplies oil to the power unit and detects a change in a chamber pressure of itself in real time, the switch control device triggers the oil supply device to supply oil to the pressure compensation device if the chamber pressure is less than a predetermined first threshold and triggers the oil supply device to stop supplying oil to the pressure compensation device if the chamber pressure is greater than a predetermined second threshold.

CN 201520281074 U discloses, according to a translation of the abstract, a deep sea valve actuating mechanism with two-way pressure dynamic balance compensation arrangement, which includes actuating mechanism, piston pressure balance compensator and valve adapting unit, piston pressure balance compensator is located the actuating mechanism outside and with actuating mechanism connects, actuating mechanism passes through valve adapting unit is connected with valve under water. Actuating mechanism includes an actuating mechanism casing, a pneumatic cylinder end cover, a piston rod, a driving sleeve, a spring holder and a plurality of spring, piston pressure balance compensator includes pressure balance ware casing, and pressure balance ware casing one side is provided with the filtration end cover, and the opposite side passes through the connecting axle to be connected with actuating mechanism, is provided with the piston in the pressure balance ware casing, and the piston divide into dynamic balance chamber and sea water compensated cavity with the equalizer casing.

There is therefore a need for a method and a system to overcome the above mentioned problems.

### SUMMARY OF THE INVENTION

### Problems to be Solved by the Invention

Therefore, a main objective of the present invention is to provide a system and a method for a hydraulic motor.

### Means for Solving the Problems

The objective is achieved according to the invention by a pressure annulling unit as defined in the preamble of claim 1, having the features of the characterising portion of claim 1, a method for operating a pressure annulling unit as defined in the preamble of claim 3, having the features of the characterising portion of claim 3, a hydraulic motor as defined in the preamble of claim 4, having the features of the characterising portion of claim 4, and a method to operate a hydraulic motor as defined in the preamble of claim 5, having the features of the characterising portion of claim 5.

A number of non-exhaustive embodiments, variants or alternatives of the invention are defined by the dependent claims.

The present invention attains the above-described objective by a pressure annulling unit that can selectively annul the ambient pressure outside the pressure annulling unit.

### Effects of the Invention

The technical differences over traditional hydraulic systems is that the pressure annulling unit is able to selectively annul the ambient pressure outside the pressure annulling unit.

These effects provide in turn several further advantageous effects:
it makes it possible to operate hydraulic systems with less power,
it makes it possible to operate systems with less pressure since the ambient pressure is annulled, and
it makes it possible to use lighter materials since the differential pressures can be made lower.

### BRIEF DESCRIPTION OF THE DRAWINGS

The above and further features of the invention are set forth with particularity in the appended claims and together with advantages thereof will become clearer from consideration of the following detailed description of an [exemplary] embodiment of the invention given with reference to the accompanying drawings.

The invention will be further described below in connection with exemplary embodiments which are schematically shown in the drawings, wherein:

FIG. 1 shows an exception to the Archimedes Buoyancy Principle,

FIG. 2 shows the principle of FIG. 1 applied to a pressure annulling unit,

FIG. 3 shows the annulling unit in detail,

FIG. 4 shows a P-V diagram,

FIG. 5 shows the annulling unit at position A of the P-V diagram,

FIG. 6 shows the annulling unit at position B of the P-V diagram,

FIG. 7 shows the annulling unit at position C of the P-V diagram,

FIG. 8 shows the annulling unit at position D of the P-V diagram,

FIG. 8B shows the forces acting on annulling unit at position D of the P-V diagram, and

FIG. 9 shows an application of an annulling unit as a heave compensator with a payload.

### Description of the Reference Signs

The following reference numbers and signs refer to the drawings:

| | |
|---|---|
| 100 | The system |
| 105 | Payload |
| 200 | Annulling unit |
| 202 | Annulling body |
| 210 | Lower chamber |
| 212 | Lower vertical cylinder |
| 214 | Lower vertical piston |
| 216 | Lower vertical shaft |
| 220 | Middle chamber |
| 222A | First horizontal cylinder |
| 222B | Second horizontal cylinder |
| 224A | First horizontal piston |
| 224B | Second horizontal piston |
| 230 | Upper chamber |
| 232 | Upper vertical cylinder |
| 234 | Upper vertical piston |

### DETAILED DESCRIPTION OF THE INVENTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The invention will be further described in connection with exemplary embodiments which are schematically shown in the drawings, wherein:

### Principles Forming the Basis of the Invention

FIG. 1 shows one exception to the well known Archimedes Buoyancy Principle (ABP), which is the basis for the invention. The exception arises when a submerged object is not fully enclosed by a continuous fluid. This exception can occur when the submerged object is in fluid excluding contact with a vessel that contains the fluid, for instance if a cube is resting on the bottom of a pool. At this point, the sum of forces acting horizontally still cancel out, just as for the normal case of ABP. However the vertical forces will be different. The forces acting downward, will be the area integral of the pressure acting on the top surface at the height of the cube. This can be written as

$${F}_{pressure force} = - \hat{k} [ {P}_{atm} - ρ \text{?} g \vert h \text{?} \vert ] A$$

$$\text{?} \text{indicates text missing or illegible when filed}$$

wherein
1. -k indicates that the force is pointing downwards along the z-axis (negative along the z-axis in FIG. 1).
2. The term [Patm+ρ_{f}g|hₜₒₚ|] is the pressure exerted on the top surface of the submerged cube and term ρ_{f}g|hₜₒₚ| is increasing linearly with depth.

This is in contrast with the normal ABP conditions, where the force can be written as

$${F}_{B} = {ρ}_{f} {V}_{disp , f} g \hat{k} = {m}_{f , disp} g \hat{k} = ( constant ) \hat{k}$$

wherein
p_{f} is the density of the fluid,
V_{disp,f} is the displaced volume of the fluid,
g is the acceleration of gravity,
\hat{k} is the unit vector, pointing in the upwards direction of the z-axis, and
m_{f,disp} is the total mass of the displaced fluid volume (V_{disp,f})

The inventor has realised that the above can be exploited to device a system wherein forces are located on opposite sides of a central unit and operating so that the forces act in opposite directions, thereby cancelling the forces.

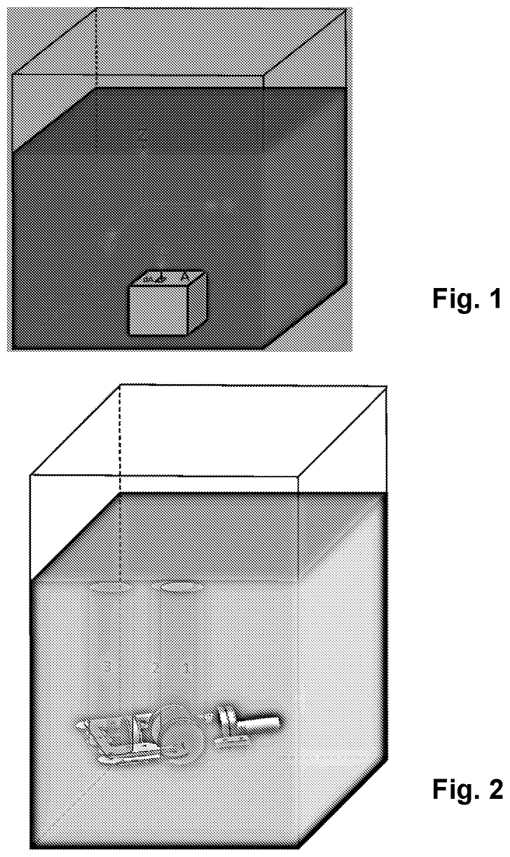

FIG. 2 shows the principle of FIG. 1 applied to a pressure annulling unit, where forces are cancelled by forces acting in opposite directions. The indicated columns of water relate to Pascal's Law, showing how much force is applied to each piston. The facing pistons cancel their forces, while the wires applies forces on the third piston also cancelling the forces applied to that piston. This leaves the forces on the fourth piston, provided opposite of the third piston.

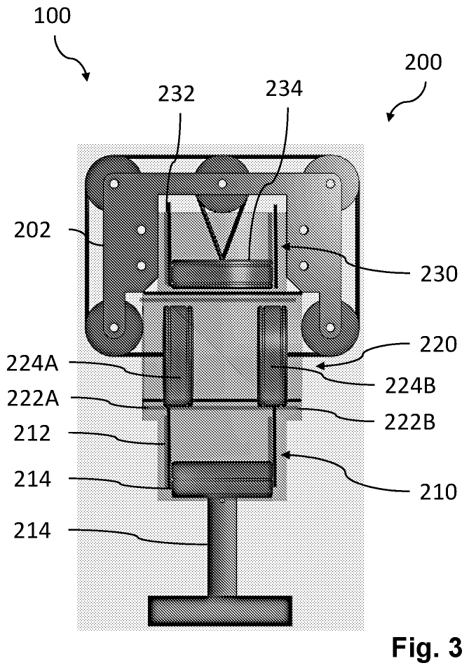

FIG. 3 shows the annulling unit 200 in detail. The unit is a hollow annulling body 202 having a cavity provided with a plurality of cylinders to receive one or more pistons.

In one embodiment the cavity is sub divided into three chambers:
a lower chamber 210 comprising a lower vertical piston 214 provided inside a vertical cylinder 212;
a middle chamber 220 comprising a first 224A and a second 224B horizontal piston moveably provided inside a corresponding first 222A and a second 222B horizontal cylinder, wherein the first and second pistons are located opposite to each other, so that the hydrostatic pressure from either cancel:
an upper chamber 230 comprising an upper vertical piston 234 provided inside a vertical cylinder 232.

The first and second pistons 224A, 224B are operatively connected to the upper vertical piston 234 in such a way that an inward movement of the first and second pistons will cause an outward movement of the upper piston, using wires and pulleys.

The lower chamber 210 is provided with an air hose and an air vent attached to it, such that air can be supplied to this chamber when necessary. The air vent can also be closed and opened. This is all operated from above the sea surface, on land. The middle chamber 220 is provided with an air vent attached to it, which is closed before the annulling unit is submerged in water. That is, no air is supplied to this chamber.

Pistons have an outer face that is exposed to a fluid surrounding the annulling unit, and an inner face that is exposed to the respective volumes of each chamber.

The lower, upper and middle chambers are provided with means for adding or removing fluid enclosed in the chambers.

Typically, the upper chamber 230 is provided with air hose attached to it which is constantly open, such that air can freely flow in and out from this chamber, if the volume of the middle chamber 220 changes. In this case, the upper chamber 230 has a constant pressure of P=1 bar (the atmospheric pressure).

A first horizontal piston is moveably provided inside a corresponding first horizontal cylinder, wherein the first horizontal piston is operatively connected to an upper vertical piston moveably provided inside a corresponding upper vertical cylinder. Similarly a second horizontal piston is moveably provided inside a corresponding second horizontal cylinder, wherein the second horizontal piston is operatively connected to the upper vertical piston. The first and second pistons are located so that the hydrostatic pressure from either cancel.

The first and second horizontal pistons are operatively connected to the upper vertical piston in such a way that an inward movement of the first and second pistons will cause an outward movement of the upper piston. This can be achieved using mechanical linkage such as rods or wires and pulleys.

Typically, the cavity is filled with a compressible fluid, whereas the surrounding fluid can be incompressible such as a liquid. Such a liquid may for instance be water.

Thus, when the unit 200 is lowered into a pool, the pressure inside the cavity will reflect the difference in pressure as explained in the exception to the ABP. This difference can be applied to perform work in a way that is different from a single cylinder with a piston enclosing a closed working medium.

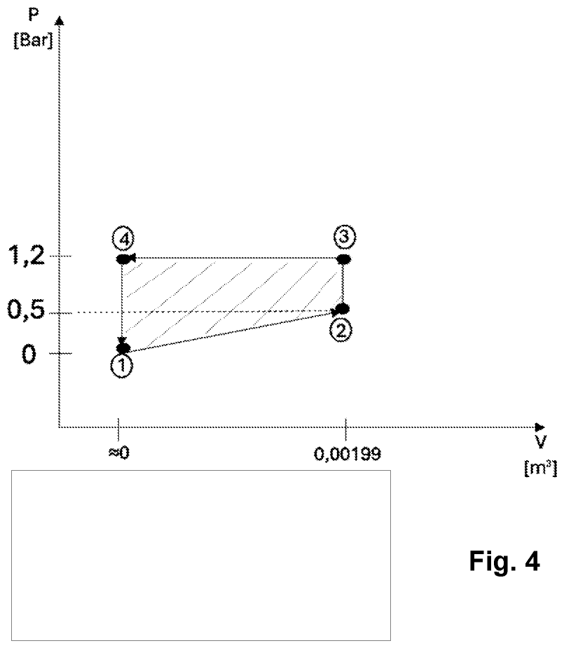

FIG. 4 shows a P-V diagram, having four corner positions. The principle of the invention is to use the annulling unit to lower the effective pressure experienced by at least one of the chambers, thus reducing the effective work done in order to move at least one piston. In the following example, the lower piston is the one doing the effective work, while the three other pistons act to annul at least parts of the effective external pressure acting on the lower piston.

Transitions shown in the P-V diagram takes place by transferring fluid in and out of the chambers. A line in a cycle of a P-V diagram that traces back on itself will not enclose an area and therefore not do any work. It is the transition from step 2 to step 3 that opens the trace so that the integral becomes non-zero. The opening takes place by stopping the annulling effect, which then is restated in the transition from step 4 back to step 1.

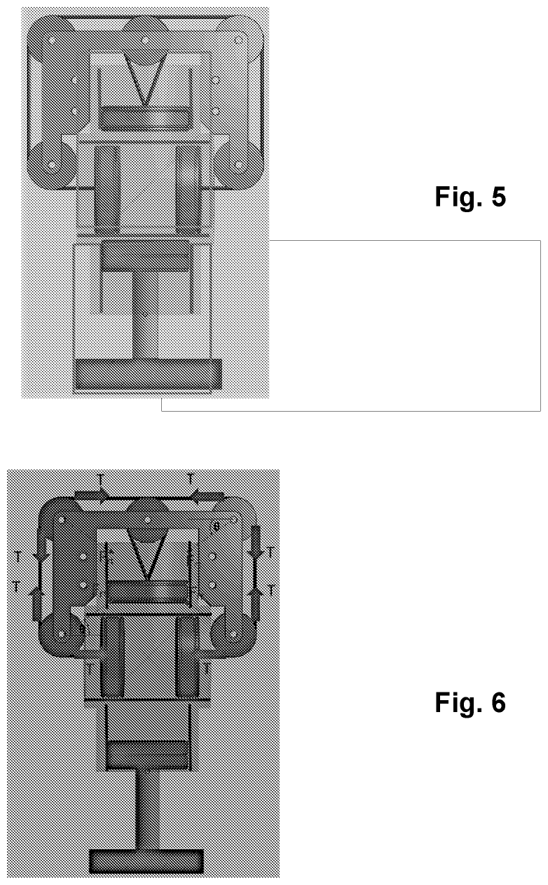

FIGS. 5-8 show an example of a typical cycle in the form of a pressure-volume (PV) diagram, illustrating the energy transfer. In this configuration, the chambers are configured as follows, where chamber 1 corresponds to upper chamber 230, chamber 2 corresponds to middle chamber 220, and chamber 3 corresponds to lower chamber 210:
Chamber 1: This chamber is provided with an air hose and an air vent attached to it, such that air can be supplied to this chamber when necessary. The air vent can also be closed and opened. This is all operated from above the sea surface, on land.
Chamber 2: This chamber is provided with an air vent attached to it, which is closed before the pressure annulling unit is submerged in water. That is, no air is supplied to this chamber.
Chamber 3: This chamber is provided with an air hose attached to it which is constantly open, such that air can freely flow in and out from this chamber, if the volume of chamber 2 changes. Moreover, chamber 3 has a constant pressure of P=1 bar (the atmospheric pressure).

FIG. 5 shows the system at state 1 in FIG. 4, which is the starting position.

At state 1, the pressure annulling unit is separated into two systems. System one is comprises chamber 2 and its corresponding pistons and chamber 3 and its corresponding piston. System two comprises only the fixed lower piston and the lower vertical shaft which is holding the lower piston fixed. That is, in state 1, there is no contact between the fixed piston and the end of chamber 1.

### State 1→State 2:

The piston in chamber 1, is kept in a fixed position, as shown in FIG. 5. Air with pressure is now supplied to chamber 1, and as such, the pressure annulling unit will leave state 1 and move towards state 2 as the volume in chamber 1 increases. Typically the pressure will increase while increasing the volume, since the pressure is not increased instantaneously, especially if the valve is on the surface and the air hose takes time to pressurise before bringing air into chamber 1.

FIG. 5 also shows the pulley forces acting on the pressure annulling unit the volume of chamber 1 is increasing and approaching the maximum expansion. Note how the equilibrium of the pressure annulling unit is when the fixed piston has no contact with the end of chamber 1. The fixed piston is no longer in contact with the end of chamber 1, and as such, the pistons in chamber 2 and the piston in chamber 3 will form a new equilibrium.

FIG. 6 shows the system at state 2 in FIG. 4, which is the end position of the expansion. The pressure annulling unit is in equilibrium, while the fixed piston is separated from the end of chamber 1.

### State 2→State 3:

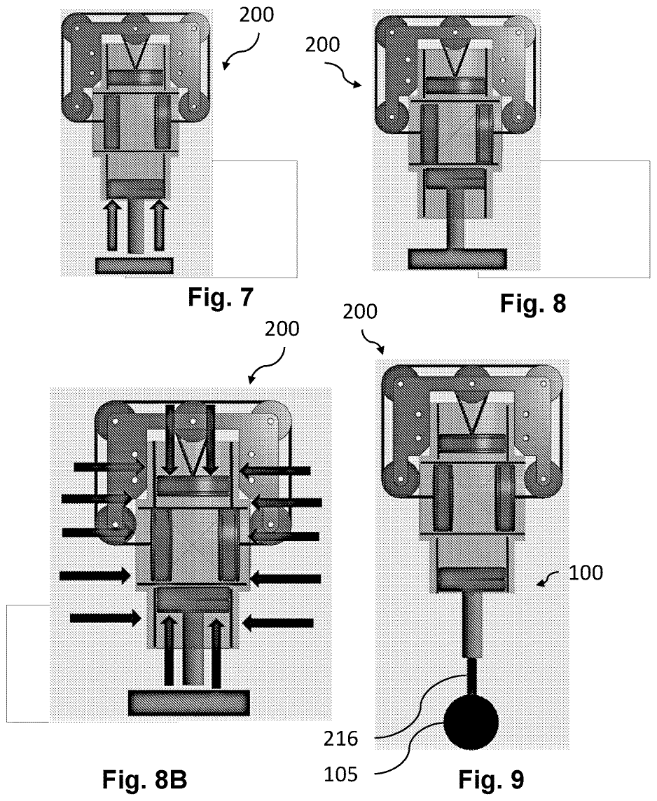

The piston corresponding to chamber 1 is now released from its fixed position and the air vent in chamber 1 is opened. This means that the full ambient pressure is now applied directly to chamber 1, and the pressure thus increases, typically as rapidly as the release is completed. The pressure annulling unit is now leaving state 2 and entering state 3 as the piston in chamber 1 is released from its fixed position FIG. 7 shows the system at state 3 in FIG. 4, which is the starting position for the transition where the piston in chamber 1 is forced in by the surrounding pressure, reducing the volume V.

### State 3→State 4:

After the piston corresponding to chamber 1 is released, the volume of chamber 1 will be reduced as the piston will move inwards to chamber 1. The water pressure acting on the piston will press the piston inwards to chamber 1 with a water pressure of P=1.2 bar, and the moving piston will push out the air in chamber 1 through the air hose.

The piston corresponding to chamber 1 has now emptied the volume of chamber 1, and the pressure annulling unit has entered state 4. At state 4, the pressure annulling unit is in equilibrium like a regular piston and cylinder system. This is illustrated in FIG. 8B. The pressure on the pressure annulling unit shown in FIG. 7 is a result from the pressure annulling unit being submerged.

FIG. 8 shows the system at state 4 in FIG. 4, where the piston in chamber 1 now once more is in full contact with the end of the cylinder. Only in state 4 is the piston in direct contact with the end of the cylinder and the annulling effect does not take place.

State 4→state 1:

The piston corresponding to chamber 1 is returned to its fixed position. Moreover, it is slightly moved away from the end of chamber 1 as shown in FIG. 8, and has no longer contact with the end of chamber 1. As such, the air pressure in chamber 1 will return to 1 bar as the air hose is open in chamber 1, and the pressure annulling unit will return to state 1. Here, the volume is approximately equal to 0 with almost no increase in volume, the increase in only to separate the fixed piston from the pressure annulling unit.

Returning to FIG. 4, it can therefore be demonstrated that the work done in this cycle, is the area enclosed by the lines between the four states.

The pressure annulling unit of this embodiment can be on or off.
When turned off, the equilibrium of the pressure annulling unit is equivalent to a regular/classic/standard piston being fully compressed into a regular/classic/standard cylinder. The pressure annulling unit is turned off in state 4 only.
When turned on, the fixed piston has NO contact with the pressure annulling unit, except for the sealings causing friction between the fixed piston and chamber 1 during expansion. Moreover, the pistons in chamber 2, and the piston in chamber 3 form an equilibrium on their own. As such, it allows for the fixed piston to be separated from the system while maintaining an equilibrium. The pressure annulling unit is turned on in state 1, state 2 and state 3 and the paths between state 1, state 2, state 3 and up to state 4.

In an example run of an embodiment, the radius of the piston in chamber 210 is r=6.5 cm, and the total depth of chamber 1 is d=15 cm, which corresponds to a maximum volume of V=0.00199 m³.

In state 1, the pressure annulling unit is submerged 12 m below sea level, which means that there is a water pressure of 1.2 bar (gauge pressure) pressing on the pressure annulling unit. Moreover, the pressure annulling unit has a total weight of 49.5 kg, and to overcome the force of gravity, there needs to be supplied air with a minimal pressure of

$$P = F / A = ( mg ) / A = \frac{40.5 kg \text{?}}{π * ( 0.065 m ) \hat{} 2} = 1 , 566 * 10 \hat{} 5 Pa = 0.366 bar .$$

$$\text{?} \text{indicates text missing or illegible when filed}$$

Note that the radius of the piston in chamber 1 is r=6.5 cm.

As such, the total resistance on the pressure annulling unit can be expressed as P_{water}+P_{weight}=1.2 bar+0.366 bar=1.566 bar. However, the necessary pressure needed to supply to chamber 1 is only 0.5 bar. Note that the water pressure acting on the top piston (corresponding to chamber 3) is cancelled out by the pressure acting on the pistons corresponding to chamber 2. As such, the supplied air does not have to overcome the water pressure P_{water}=1.2 bar.

When chamber 1 is increasing in volume, air is constantly supplied to chamber 1 with a constant pressure of 0.5 bar.

When transitioning from state 3 to state 4, the water pressure acting on the fixed piston will press the piston inwards to chamber 1 with a water pressure of P=1.2 bar, and the moving piston will push out the air in chamber 1 through the air hose.

When transitioning from state 2 to state 3, the effective pressure increases from 0.5 to 1.2 bar. This provides a stronger force in the transition from state 3 to state 4 where the volume contracts.

### BEST MODES OF CARRYING OUT THE INVENTION

The embodiment of the apparatus according to the invention shown in FIGS. 4-8 comprises an annulling unit that is suitable for submerged use.

### Alternative Embodiments

A number of variations on the above can be envisaged.

FIG. 9 shows an embodiment of an annulling unit, where the lower vertical shaft 216 is connected to a payload 105 to perform work.

One application is for the use of the pressure annulling unit as a heave compensator. In this embodiment, the pressure annulling unit 200 is connected by the body 202 to a surface ship, while the vertical shaft 216 is connected to a payload 105, directly or via a connecting body such as a wire. By controlling the pressures within the chambers, it is possible to hold the payload in a stable position with respect to the seafloor.

### INDUSTRIAL APPLICABILITY

The invention according to the application finds use in hydraulics, such as hydraulic motors and heave compensators.

1. A pressure annulling unit (200) comprising a hollow annulling body (202) having a cavity,
wherein the annulling body (202) is provided with a plurality of cylinders (212, 222A, 222B, 232) to receive a piston (214, 224A, 224B, 234) each, wherein:
a first horizontal piston (224A) moveably provided inside a corresponding first horizontal cylinder (222A), wherein the first horizontal piston is operatively connected to an upper vertical piston (234) moveably provided inside a corresponding upper vertical cylinder (232),
a second horizontal piston (224B) is moveably provided inside a corresponding second horizontal cylinder (222B), wherein the second horizontal piston is operatively connected to the upper vertical piston (234),
wherein the first and second horizontal cylinders (222A, 224B) are in fluid communication with each other inside the hollow annulling body (202), and
the first and second horizontal pistons (224A, 224B) are located opposite to each other so that the hydrostatic pressure from either horizontal piston cancel,
further comprising a lower vertical piston (214) moveably provided inside a corresponding lower vertical cylinder (212),
wherein the four pistons, when the pressure annulling unit is immersed in a fluid, have the pistons respective outer surfaces being connected to the surrounding fluid.

2. The pressure annulling unit (200) according to claim 1, wherein the first and second horizontal cylinders (222A, 224B) are in the form of one continuous cylinder.

3. A method for operating a pressure annulling unit (200) according to claim 1, starting from state 1 wherein there is no contact between a fixed piston and the end of a chamber 1, comprising the steps:
A: supplying fluid under pressure to lower vertical cylinder (212), so that the pressure annulling unit will leave a state 1 and move towards a state 2 as the volume in chamber 1 increases, until the lower vertical piston (214), so that lower vertical piston (214) no longer is in contact with the end of lower vertical cylinder (212) 1;
B: releasing the lower vertical piston (214) from its fixed position and opening the vent fluidically connected to the lower vertical cylinder (212), so that the pressure annulling unit leaves state 2 and enters a state 3;
C: allowing the ambient pressure acting on the lower vertical piston (214) to press the lower vertical piston (214) inwards to lower vertical cylinder (212) so that the moving piston will push out the fluid in the lower vertical cylinder (212) through the vent fluidically connected to the lower vertical cylinder (212), until lower vertical piston (214) has emptied the lower vertical cylinder (212), and the pressure annulling unit has entered a state 4 where the pressure annulling unit is in equilibrium;
D: bringing the lower vertical piston (214) at least partially away from the end of the lower vertical cylinder (212), so that the fluid pressure in the lower vertical cylinder (212) will return to the ambient pressure as vent operatively connected to the lower vertical cylinder (212), is opened, wherein the pressure annulling unit will return to state 1.

4. A hydraulic motor (100) for converting energy, comprising:
a pressure annulling unit (200) according to claim 1, wherein the lower vertical piston (214) is operatively connected to an actuator to perform work.

5. A method to operate a hydraulic motor (100) according to claim 4, the steps comprises:
a. changing the depth of the pressure annulling unit (200),
b. let the lower vertical piston perform work, wherein the work (W) is distance (d) moved by the lower piston times the force (F), which is a pressure differential between cavity pressure and outer fluid pressure (delta P) times area (A) of the lower piston.
